(19) United States
(12) Patent Application Publication
(10) Pub. No.: US 2007/0253781 A1
(43) Pub. Date: Nov. 1, 2007

(54) Cable Injector And Puller For Pipe Bursting

(75) Inventors: Cody L. Sewell, Perry, OK (US); Kelvin P. Self, Stillwater, OK (US); David R. Bazzell, Perry, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: The Charles Machines Works, Inc., Perry, OK (US)

(21) Appl. No.: 11/739,592

(22) Filed: Apr. 24, 2007

Related U.S. Application Data
(60) Provisional application No. 60/745,487, filed on Apr. 24, 2006.

(51) Int. Cl. F16L 55/18

(52) U.S. Cl. 405/184.3

(57) ABSTRACT

A cable handling apparatus and method for using the same in pipe bursting applications. In one mode, the apparatus injects a cable through at least one gripping element and into a pipe. Protrusions open the at least one gripping element to allow the cable to feed through freely. The cable is fed by a powered injection pulley. In another mode, the apparatus pulls a pipe burster, attached to the cable, through a length of pipe. In a preferred embodiment comprising two cable grippers, each cable gripper grips the cable in a first position, pulls the cable until the cable gripper is a second position, then returns to the first position. The apparatus is adapted such that a first cable gripper is in the first position when a second gripper is in the second position. Alternatively, the cable grippers may move from the first position to the second position in tandem. The cable handling apparatus further comprises a reel. The reel is used to store excess cable and impart additional force on the cable.

### CROSS REFERENCE TO RELATED APPLICATIONS

This application claims priority of U.S. Provisional Patent Application No. 60/745,487, filed Apr. 24, 2006 the contents of which are incorporated fully herein by reference.

### FIELD OF THE INVENTION

This invention is related to the field of underground pipe replacement equipment, and more specifically to cable injection and pipe splitting and replacement equipment.

### SUMMARY OF THE INVENTION

In one aspect the present invention is directed to an assembly for bursting an underground pipe. The assembly comprises a cable, at least one gripping element, and a cable injection system. The cable is connectable to a pipe bursting head. The at least one gripping element comprises a wedge and is adapted to exert a force on the cable. The cable injection system comprises a wheel. The cable injection system is adapted to feed the cable through the at least one gripping element.

In another aspect, the present invention is directed to a method for bursting an underground pipe. The method comprises the steps of feeding a cable through at least one gripping element, feeding the cable through a length of an underground pipe, attaching a pipe bursting head to an end of the cable, and pulling the pipe bursting head through the length of the underground pipe with the at least one gripping element.

### BRIEF DESCRIPTION OF THE DRAWINGS

FIG. 1 is a side perspective view of a cable handling apparatus.

FIG. 2 is a side view of a cable handling apparatus used with a pipe burster.

FIG. 3 is a cut-away view of an anchor for attachment of a cable to a pipe burster.

FIG. 4 is a front perspective view of a cable handling apparatus.

FIG. 5 is a cut-away side view of a cable handling apparatus.

FIG. 6 is a depiction of a cable gripping element.

FIG. 7 is a cut-away bottom view of a cable handling apparatus.

FIG. 8 is a side view of an alternative cable handling apparatus in a cable injection mode.

FIG. 9 is a cut-away side view of an alternative embodiment of a cable handling apparatus.

FIG. 10 is a side view of an alternative embodiment of a cable handling apparatus.

FIG. 11 is a side view of an alternative embodiment of a cable handling apparatus.

### DETAILED DESCRIPTION OF THE DRAWINGS

It should be understood that the figures described herein serve as examples illustrating how the functional aspects of the invention may be implemented. Therefore they are not limiting upon the present invention.

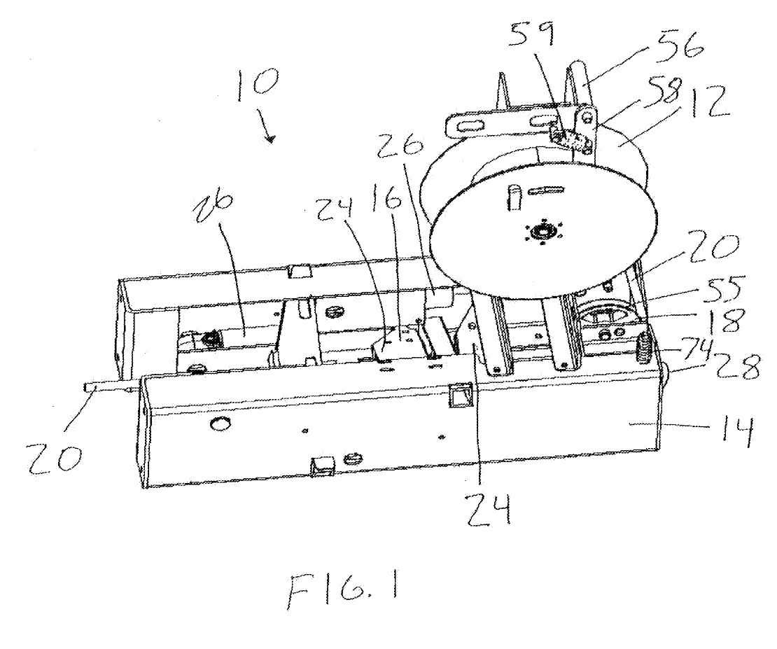

Turning now to the drawings in general and FIG. 1 in particular, shown therein is a compact cable handling system 10. The cable handling system 10 comprises a reel 12, a frame 14, a cable pulling system 16, and a cable injection system 18. The reel 12 provides storage for a cable 20, and may be adapted to place tension on the cable 20. The reel 12 is supported on the frame 14. The cable pulling system 16 is supported on the frame 14 and adapted to pull a cable attached to a pipe bursting head through a length of underground pipe. The cable pulling system 16 comprises at least one gripping element. Preferably, the cable pulling system 16 comprises two gripping elements 24 and a plurality of cylinders 26. These gripping elements 24 can be operated in either a hand-over-hand fashion or in tandem by the cylinders 26. Preferably, the cylinders 26 are arranged in pairs. More preferably, the pairs of cylinders 26 are not co-planar, allowing for a more compact design, as is described in more detail below. The cable injection system 18 comprises an injection pulley 28. The injection pulley 28 injects the cable 20 into a pipe 30 through the at least one gripping element 24, each of which is deactivated in a manner yet to be described.

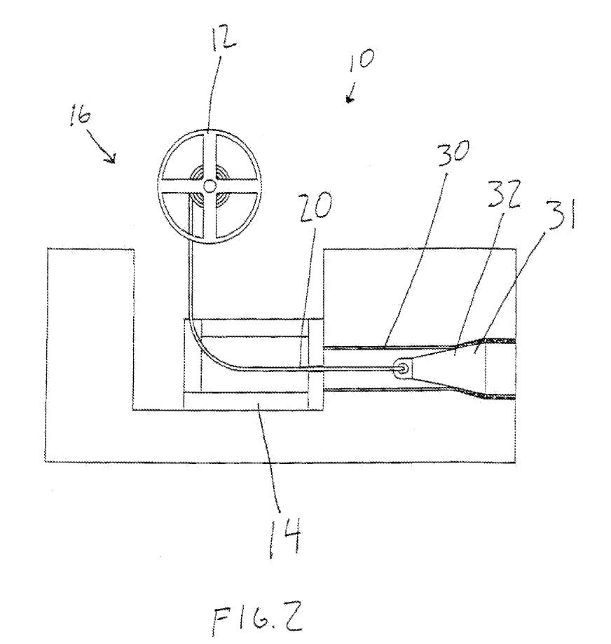

With reference now to FIG. 2, an alternative cable handling system 10 is adapted for use with a pipe bursting head 31 for bursting and replacement of pipes. Generally, a cable 20 is placed through a length of pipe 30 to be replaced, and fixed to the bursting head 31 at a distant end of the pipe. The bursting head 31 is typically comprised of a gently tapered conical body 32, hollowed out to reduce weight and to accept the cable 20. The conical surface 32 has a varying diameter small enough at a leading end to fit inside an existing buried pipe 30 to be replaced. The existing pipe 30 breaks up or is stretched until it splits under the radial force created by the interference fit of the enlarging, oversized conical body 32. The pulling effort to split the deteriorated pipe 30 and any fittings or previously applied repair clamps may be reduced by known add-ons to (or preceding) the conical surface 32. These may include knife-like wedges or rolling cutters that deeply scribe the existing pipe longitudinally as the splitting assembly advances, thereby reducing the hoop strength of the pipe 30. The pipe bursting head 31 may terminate at its distal end in a reduced diameter suitable for attaching the replacement pipe (not shown), which is typically pulled into place directly behind the advancing splitter. The conical surface 32 is of appropriately enlarged diameter at its trailing end to create a hole sufficiently larger than the outside diameter of the replacement pipe so as to minimize likelihood of its damage by encountering sections of the split or fragmented pipe.

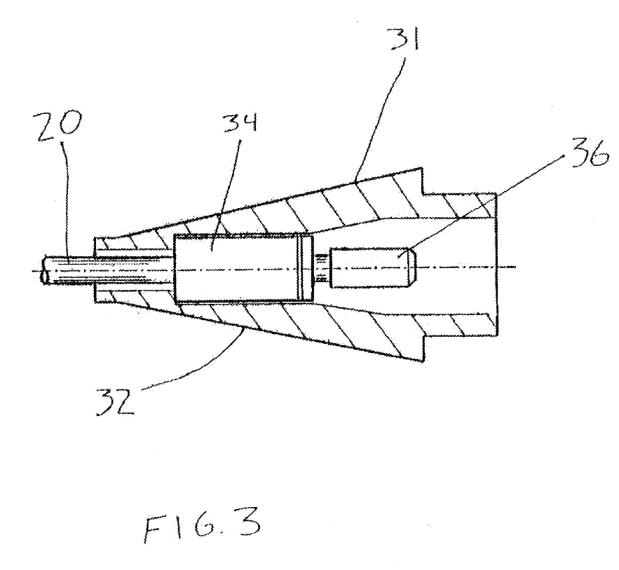

A variety of techniques have been utilized to couple the bursting head 31 to the cable and effectively react to the pulling force of the cable pulling system 16 which may be in excess of 60,000 pounds. With reference now to FIG. 3, a wedge-type anchor 34 is shown. The anchor 34, commonly used for anchoring of cable tendons in the post-tensioning concrete, is suitable not just for one-time application and long-term holding ability, but also for multiple re-use. Once the cable 20 has been injected into and through the length of existing buried pipe an end piece 36 of the cable 20 is passed through the bursting head 31 sufficiently to expose a short segment of cable 20. The wedge-type anchor 34 may now be assembled onto the cable end 36. The wedge-type anchor comprises an outer sleeve, an o-ring, an engagement spring and a threaded retaining cap. The outer sleeve is first slipped over the cable end piece, followed by the o-ring, the engagement spring and, finally, by the threaded retaining cap. Before assembly, a conical set of tapered wedges are arranged around the cable and restrained thereon by the elasticity of the o-ring. During assembly, threading the retaining cap onto the outer sleeve compresses the spring against the set of wedges and forces their conically tapered outer surfaces along the similarly conically tapered interior of the outer sleeve. This action squeezes the serrated bore of the set of wedges against the cable to grip it sufficiently securely for the anchor assembly to resist the maximum pulling capability of the cable handling system 10. Even so, the anchor can readily be removed by its disassembly.

Referring again to the embodiment shown in FIG. 2, the cable pulling system 16 utilizes the reel 12 above-ground for the take-up and payout of the cable. This allows the reel 12 to be of enlarged diameter and/or of greater width for increased length-holding capacity of cable 20. The structure for supporting the reel 12 may rest on the ground surface above the frame 14. Additionally, or even alternately, the reel 12 supporting structure may be anchored to the frame 14 in telescopic, quickly attachable/detachable manner. The latter arrangement enables proper alignment of the powered reel 12 as well as alignment with associated components that are useful during the take-up of cable 20.

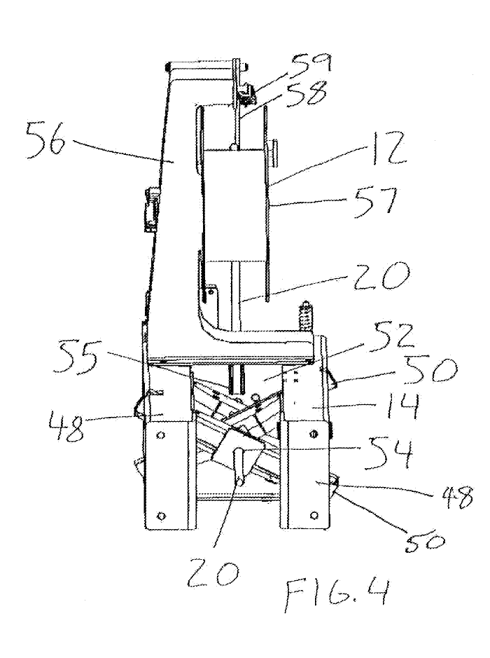

Turning to now FIG. 4, the frame 14 of the compact cable handling system 10 is shown in greater detail. The frame 14 is comprised of two or more longitudinal members 48 interconnected by a plurality of cross-members 50 and a rear plate 52. Preferably, the cross-members 50 comprise a front cross-member and a rear cross-member, presenting diagonal oppositely disposed cross-members. The front of the frame 14 has an open center for passage of the cable 20 and retrieval of a pipe bursting head 31. The diagonally disposed cross-members 50 contain tubes 54 for the cable 20 to pass transversely through respective mid points. This may be accommodated without loss of strength by incorporating appropriately sized tubes 54. These cable passage tubes 54 protrude rearward an appropriate amount from their respective cross-members 50 for purposes later described. Preferably, the front cross-member is massively reinforced to withstand the full pulling power of the cable handling system 10 in the event an attachment to the cable end 36 is inadvertently drawn against it.

To aid in achieving compactness of the cable handling system 10, an idler pulley 55 converts an approximately horizontal line of pull to an approximate vertical line of tangency where the cable 20 wraps onto the reel 12. The reel 12 is supported from the frame 14, for instance by way of a reel supporting structure 56. Preferably the reel 12 is mounted on a reel drive axle 57 for powered or free-wheel rotation—as different operating modes of the cable handling system 10 dictate. The reel drive axle 57 may be an output shaft of a hydraulic motor. The reel drive axle 57 will preferably exert tension on the cable 20 when the cable handling system 10 is in a cable pulling mode.

As is well known, control valves (not shown) are available to selectively rotate the output shaft of the drive motor in a manner causing the reel 12 to take up the cable or alternately allowing its free-wheel rotation by cross-connecting the motor inlet and outlet ports. The latter mode of operation is utilized when deploying the cable from the reel 12 by way of the cable injection system 18 to be later described. A cable follower 58 may also be provided, useful in reducing the likelihood of slack developing in the windings on the reel 12 during free-wheeled unspooling of the cable 20, or whenever a pulling load is absent or abruptly diminishes. The cable follower 58 may be pivotally supported from the reel supporting structure 56 and biased against the wraps of cable on the reel 12 by a spring 59. The pivot arm of the follower 58 has a distal end sized to fit between the outer flanges of the reel 12 while broad enough to prevent a wrap of cable 20 from undesirably escaping there between. Its broad distal end may be of fixed construction; alternately, a bearing-mounted wheel or roller may be utilized to reduce friction against the cable 20. The contact pressure of the follower 58 pivot arm against the cable 20 as it is wrapped onto the reel 12 also tends to “level” newly laid windings across the width of the reel without the added complexity of employing a level-wind.

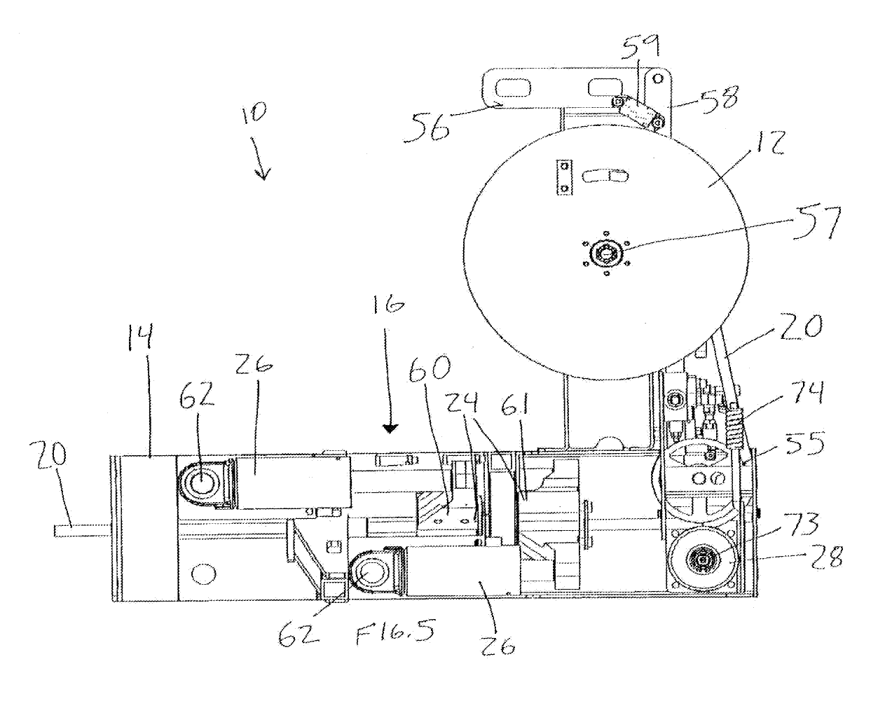

With reference to FIG. 5, the cable pulling system 16 comprises the at least one cable gripping element 24. Preferably, the cable pulling system 16 comprises a first cable gripping element 60 and a second cable gripping element 61. Each of the at least one cable gripping members 24 is movably supported by the frame 14. Preferably, each of the gripping members are moved by a pair of hydraulic cylinders 26. Preferably, a body portion of the hydraulic cylinders are fixedly attached to the frame 14 by mounting pins 62. The gripping elements 24 are supported on respective rod ends of the paired hydraulic cylinders 26. Additional fixturing may be provided to insure parallel extension and retraction of the paired hydraulic cylinders 26. Mounting of the hydraulic cylinder 26 pairs in a lengthwise partially overlapping arrangement within opposite, essentially cross-diagonal longitudinal planes of the frame 14, as shown in FIG. 4, allows their extension (stroke) to traverse a larger percentage of the length of the frame. Thus the frame 14 can be of compact length, a desirable feature when the cable handling system 10 is operated from an excavated pit.

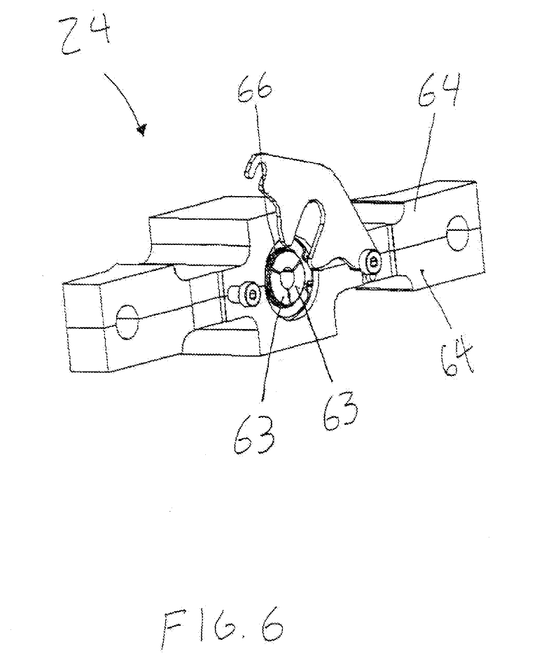

Referring now to FIG. 6, each of the at least one cable gripping members 24 further comprises a plurality of cable gripping dies 63 and a pair of mirror-image crossbars 64. Preferably, the gripping dies 63 and the crossbars 64 are secured by bolts or other fasteners. The paired crossbars 64 span between the rod ends of the paired hydraulic cylinders 26. Outward tapering of the crossbars 64 provides a good strength to weight ratio, while providing space centrally for a machined cavity 66 to accept the opposed pair of dies. Lubricant may be applied to the outside of the dies 63 to facilitate movement of the dies into the cable gripping members. The cable 20 is gripped uniformly within the dies 63, rather than being pinched tighter by one end or the other of the paired dies. Longer useful life of the cable 20 thereby results. It should be clear that toothed interior is so profiled that the gripping dies 63 reliably grip the cable 20 when a gripping member 24 is moved in one direction by its supporting hydraulic cylinders 26, but readily slip along the cable when moved in the opposite direction.

With reference again to FIG. 5, the cable gripping members 24 are positioned such that their cable gripping dies 63 will pull the cable 20 in approximate alignment with its tangential wrap around the idler pulley 55. The cable 20 is further held in contact with the idler pulley 55 by the powered take up of slack cable onto the reel 12. During this cable pulling mode, the pulley 55 is free-wheeled.

In a preferred embodiment, a method of operating the cable pulling system 16 comprises using the gripping members 24 to alternately pull and release the cable 20. Each gripping member 24 is movable between a first position and a second position. The cable gripping members 24 are preferably operated in alternating sequence to impart essentially continuous motion on the cable 20—the equivalent of hand-over-hand pulling on a rope. Preferably, the first gripping member 60 is in the first position of the first gripping member at substantially the same time as the second gripping member 61 is in the second position of the second gripping member. One pair of the hydraulic cylinders 26 extends the first gripping member 60 to its second position with its dies gripping and pulling cable while the second gripping member 61 is retracting to its first position at which point the gripping dies 63 in the second gripping member will get a new hold on the cable 20 upon reversal of direction. Preferably, all the rod ends of the cylinders 26 are hydraulically interconnected. These connections are respectively connected to the pressure output of a hydraulic pump and to the return line to the reservoir or vice versa. Repetitively switching the pump and reservoir lines across the connections may be accomplished automatically, for instance, by way of proximity limit switches in conjunction with an appropriate electro-hydraulic control valve to control the reversal of flow paths. Alternately, a well-known reciprocating valve—which changes the flow pattern on the basis of reaching an elevated pressure that generally occurs when the extension of on the pair of cylinders 26 reaches the end of travel (stroke)—could be utilized.

In a preferable mode of operation, pressurized fluid might first be flowing to extend the first pair of cylinders 26. This forces fluid from the rod ends of these cylinders 26 into the rod ends of the second pair—which causes them to retract since their barrel ends are connected to the reservoir. A relief valve in the rod end circuit equalizes any volumetric differences between the pairs of cylinders and any internal leakage variances. When the first pair of cylinders 26 extends to a limit, pressurized fluid is switched into a second flow path while at the same time a first flow path is switched to the reservoir flow path. Now the second pair of cylinders 26 begins to extend and the first pair retracts. This hand-over-hand cable pulling process continues until stopped by the operator or automatically stopped as described below.

Although not a required feature of the present invention, it is known in control theory that the transition point where pulling cycles alternate between the gripping members 24 can be smoothed out by building-in overlap. The necessary control circuitry can readily be devised to cause one gripping member 24 to begin its pulling phase a short time (e.g., fractions of a second) prior to the other gripping member reaching the end of its pulling phase.

Alternatively, the above control method can be utilized to operate the two cable gripping members 24 in tandem. This method is advantageous when the combined force of the gripping members 24 is desired. However, the tension on the cable 20 will be significantly lessened when the gripping members 24 are moving from their respective second positions to their first positions. During that period of time, the cable reel 12 may exert a force on the cable 20 to lessen the resultant retraction of the cable.

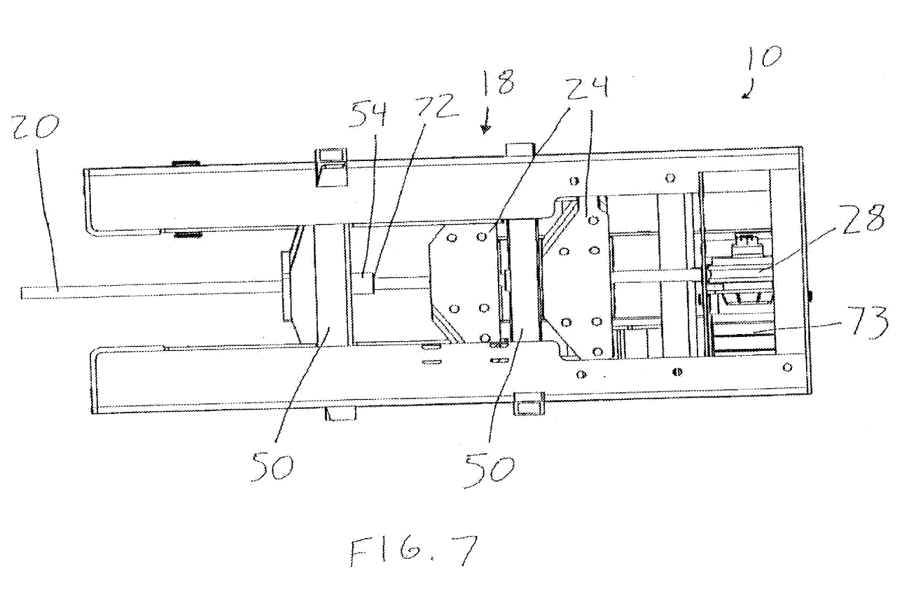

Turning now to FIG. 7, the cable injection system 18 of the present invention will be described. The cable injection system 18 comprises protrusions 72 of the cable passage tubes 54 and the injection pulley 28. One skilled in the art will appreciate the opposed gripping dies 63 prevent efficient injection of the cable 20 into the pipe 30 when the dies are operable. The dies 63 are advantageously circumvented in the present invention whenever the cable gripping members 24 are moved to an injection position. It is particularly advantageous to temporarily remove gripping bias from both gripping members 24 before deploying the cable 20 from its reel 12 for connection to a load to be pulled by the cable pulling system 16. Circumventing the gripping biases may be positively and readily accomplished by impinging noses of the paired gripping dies 63 against the protrusions 72 of the cable passage tubes 54 in respective diagonal cross members 50. With further retraction of the cylinders 26, the cavities 66 in the gripping members essentially “absorb” these protrusions 72—which cause the dies 63 to move transversely away from the cable 20 as the cavities move back relative to them. The protrusions of the cable passage tubes 54 are sized such that the grip of both paired sets of dies 63 is sufficiently loosened to freely pass the cable 20. This is further aided by the immediately adjacent cable passage tubes 54 effectively centralizing the cable 20 within the released grip pairs. The narrow end of each die cavity 66 may be reamed from rectangular to circular a sufficient size and depth to readily pass over the cylindrical protruding ends 72 of the cable passage tubes 54.

After purposeful temporary release of the gripping dies 63, the cable 20 may be advantageously power-deployed from the reel 12 of the cable handling system 10 for connection to a load by way of the cable injection system 18. A pivot arm supports a hydraulic motor 73 having an output shaft that rotationally supports and, at appropriate times, powers the injection pulley 28. The cable passes from the reel 12 around a quadrant of the idler pulley 55 and through a variable gap between the idler pulley and the injection pulley 28. The range of pivotal motion granted to the pivot arm allows this gap to close and pinch the cable between the two pulleys 28 and 55 under the adjustable action of a spring 74 (shown in FIG. 5). The force imparted to the cable 20 can be varied by increasing or decreasing the amount of spring force. These opposed contact forces against the cable 20 allow the rotational torque of the motor 73 to be transformed into linear thrust on the extending cable 20 being propelled through and forward of the frame 14. For instance, the cable 20 may be “injected” into a segment of existing buried pipe 30. Powered pay out of the cable 20 into a segment of existing buried pipe 30 by way of this injection process eliminates the need of blowing or fishing a line or rope through the existing pipe for use in towing the cable into the pipe. Further, this aspect of the invention eliminates the need to subsequently insert cable into gripping dies after the cable is fed. This improves efficiency and reduces the need of ancillary support equipment when utilizing the cable handling system 10 for the replacement of the existing buried pipe 30.

The success of injecting the cable 20 into a pipe 30 that has deteriorated to the point of requiring replacement may be improved by attaching an appropriately shaped end piece 36 to the cable via crimping or other positive methods. A rounded nose on this end piece 36 is less likely to become caught up in debris or encrustations that may be inside the pipe than is an exposed end of the cable having an anti-fray crimp ring. The nose is drilled axially and tapped with threads such that other shapes may be adapted to the end of the cable. For instance, an approximately spherical shape or a larger and longer cylindrical shaped end may aid the injection of the cable into some dilapidated pipes. Should this technique be unsuccessful, the conventional approach of pulling the cable 20 into the pipe 30 remains a possibility—now aided by the payout system. During the cable pulling mode, the motor inlet and outlet ports are cross-connected to allow free-wheel rotation of the pulley 28. One skilled in the art will recognize the cable injection system 18 described can be used for inserting cable 20 or other semi-flexible material through a conduit for purposes other than bursting or replacement of existent pipe. The injection system can advantageously be used separately from the pulling system and vice versa.

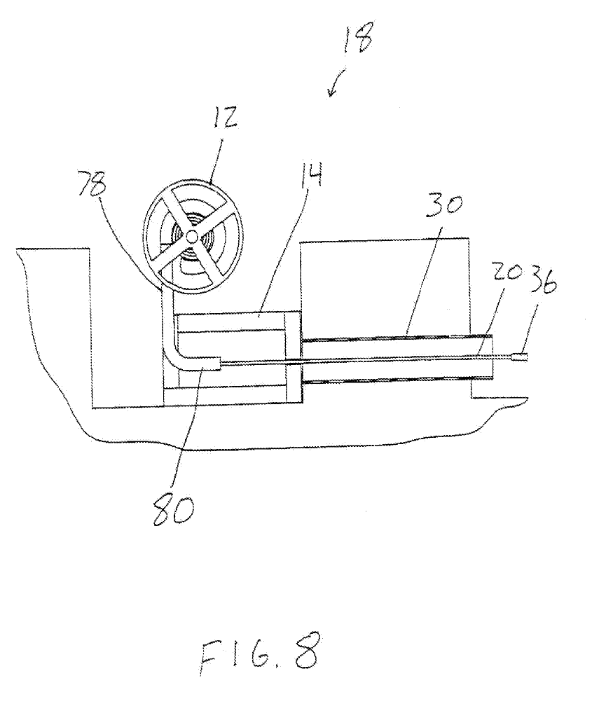

With reference to FIG. 8, an alternative embodiment for the cable injection system 18 is shown. The system of FIG. 8 comprises the powered reel 12 and a stationary cover 78 at least partially surrounding the wraps of the cable. During powered reverse rotation of the reel 12 in the deployment process, the cover 78 directs the cable into a purposefully shaped guide tube 80. The stationary cover 78 is supported from the frame 14, for instance by way of the guide tube 80. In this embodiment, the guide tube 80 replaces the payout pulley 28 and the idler pulley 55 previously mentioned. The guide tube 80 guides the cable 20 into approximate alignment with the cable passage tubes 54 which serve as cable guides during the cable deployment process. In operation, the reel 12 is power-rotated by a motor output shaft to unwind the cable 20. The multiple wraps of cable 20 presently on the reel 12 loosen to the point where one or more of the outermost wraps press against the cover and slide along its stationary surface as the reel 12 rotates. This reactionary contact and the torque required to continue rotation of the reel 12 are transformed into a thrust force on the segment of cable 20 protruding into and beyond the guide tube 80. With continued powered rotation of the reel 12, the cable 20 is injected into the segment of buried pipe 30 until its end piece reaches an access pit located distant from the pit containing the cable handling system 10. One can appreciate that the spacing between these pits must be somewhat less than the length of cable initially wound upon the reel 12.

Friction against the stationary cover 78 can be minimized by inclusion of a series of wide small diameter rollers mounted on transverse axles arrayed around the interior of the cover 78. In fact, appropriate placement of an adequate series of rollers would eliminate need of a cover. This alternate approach is somewhat similar to the cable retainer of U.S. Pat. No. 3,353,793. In the present instance, the framework supporting the rollers is restrained from rotation rather than freely floating. Additionally, with numerous layers likely needing to be unwrapped from the reel 12 at the initiation of deployment of the cable 20 inward movement of the rollers is desirable while deployment continues. This movement may be accomplished by one of several different techniques. For instance, the roller axles may be slot-mounted in their supporting framework and attached to linear actuators for their movement inward. Where these actuators are hydraulic cylinders, an appropriate supply pressure setting can be utilized to automatically control inward movement of the rollers. One skilled in the art of mechanical design can readily implement the inventive principles disclosed above.

Those knowledgeable of cable handling can appreciate the undesirability of continuing powered rotation of the reel 12 in an unspooling direction beyond the point where less than one wrap remains on the reel 12. This situation can be prevented by an automatic shut down system which may include application of a braking force to stop the rotation of the shaft in a timely manner. Initiation of shut down may be triggered by various known techniques, including measurement of the amount of cable 20 entering the guide tube 80 or passing a point on the frame 14. A sensor element or tag could also be attached to or imbedded into the cable at an appropriate location near the point of diminished remaining length on the reel 12 to be detected when it passes by the frame-mounted location of a corresponding reader, such as an RFID reader. The same techniques can be employed near the other end of the cable 20 to prevent the end piece 36 or the pipe bursting head 31 from being inadvertently pulled into the front cross member 50 under the pulling action of the cable gripping members 24.

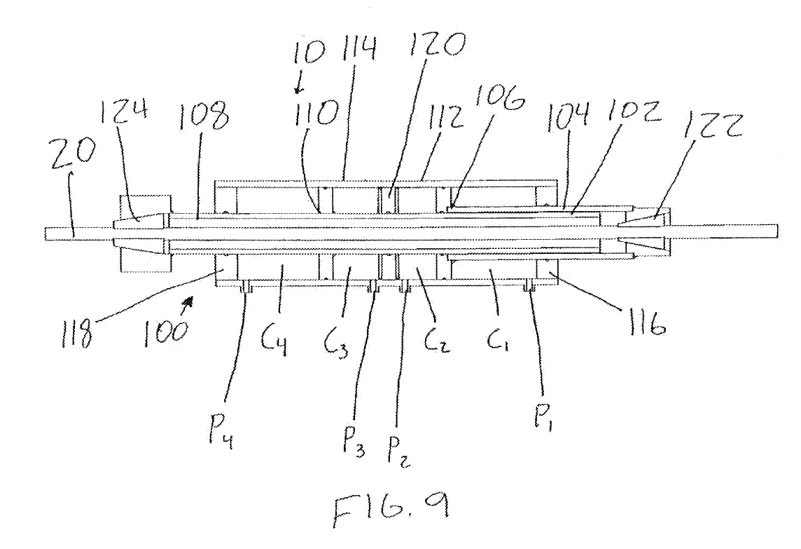

Turning now to FIG. 9, shown therein is an alternate embodiment 100 for the cable pulling assembly of the cable handling system 10, comprising a compound hydraulic cylinder 102. The compound hydraulic cylinder 102 is two separate hydraulic cylinders combined end-to-end into a single cylinder barrel assembly, which advantageously shortens overall length. A first portion 104 is comprised of a first movable piston and rod assembly 106 and functions as would a single rod-ended cylinder. A second portion 108 is comprised of a second movable piston and rod assembly 110 and acts as would a double rod-ended cylinder. A cylinder barrel assembly 112, preferably anchored to the frame 14, is comprised of a cylinder barrel 114, a first 116 and a second 118 gland end, and an internal separating section 120. The internal section 120 is preferably fixed in place by, for instance, a pair of snap rings. This fixed separating section 120 serves as the second gland end of the second hydraulic cylinder portion 108. Due to seals and the purposeful overlapping of the second cylinder rod internally of the hollow first cylinder rod, the fixed separating section 120 also serves as the barrel end cap of the first cylinder portion 104. Both cylinder rods are hollow to allow the internal passage of the cable 20 through the pulling assembly.

The compound pulling cylinder of the present invention is an improvement upon existing hollow rod, double rod-ended hydraulic cylinders utilized for pulling or pushing a string of steel rods—for instance, as shown in U.S. Pat. Nos. 5,070,948 and 4,945,999, incorporated herein by their reference—or utilized for pulling cable 20.

With continued reference to FIG. 9, the first piston and rod assembly 106 of the first cylinder portion 104 is comprised of a piston, a hollow cylinder rod and preferably seals. The protrusion of the cylinder rod through the gland end is appropriately sealed. The space lying between the gland end and the fixed separating section is divided into two chambers C₁ and C₂ useful for bi-directional, powered movement of the piston and rod assembly as in a conventional dual-action hydraulic cylinder. This is accomplished by alternatingly cross-connecting ports P₁ and P₂ to a source of pressurized hydraulic fluid or to a reservoir. Fixedly attached to a distal end of each cylinder rod is a cable gripper 122, 124 for holding a set of gripping dies 63. The gripping dies 63 preferably may move fore or aft with respect to matingly internally tapered retainers to either respectively release grip on the cable 20 or tighten against the cable. The latter direction is thus the direction the cable 20 will be pulled.

The movable piston and rod assembly 110 of the second cylinder portion 108 is comprised of a piston, a hollow cylinder rod and appropriate seals. Fixedly attached to the outer end of the cylinder rod is a cylindrical, internally tapered retainer for holding a set of gripping dies. The protrusions of the cylinder rod through the gland end and through the fixed separating section 120 are preferably sealed. The space lying there between is divided into two chambers C₃ and C₄ useful for bi-directional, powered movement of the piston and rod assembly as in a conventional dual-action, double rod-ended hydraulic cylinder. This is accomplished by alternatingly cross-connecting ports P₃ and P₄ to a source of pressurized hydraulic fluid or to a reservoir.

With appropriate hydraulic control valving the two cylinder portions 104, 108 can be operated in alternating action to apply essentially continuous pull on the cable 20. For instance, this can be accomplished by injecting pressurized fluid through port P₂ into chamber C₂ of the cylinder portion to extend the cylinder rod, while at the same time pressurized fluid is injected through port P₃ into chamber C₃ of the cylinder portion to extend the cylinder rod. (Ports P₁ and P₄ are opened to a drain line to the reservoir.) The first gripping member 122 engages the cable 20 and pulls it, whereas a second gripping member 124 disengages from the cable because of its relative motion in the opposite direction of the first gripping member. As the cylinders reach the end of stroke in their respective directions, their directions are reversed by injecting pressurized fluid through ports P₁ and P₄ while connecting ports P₂ and P₃ to the reservoir. This cyclical process may be automated by utilizing the reciprocating valve or other techniques previously described. As in the embodiment of FIG. 1, the two cylinder portions 104, 108 of the compound pulling cylinder 102 can be operated in concert (simultaneously in the same direction) to essentially double the pull applied to the cable 20. This may be accomplished by injecting pressurized fluid through ports P₂ and P₄ while connecting ports P₁ and P₃ to the reservoir. During the retraction cycle of the cylinders 104, 108, the tension in the cable 20 would be held by a separate gripping member (not shown), such as the reel 12.

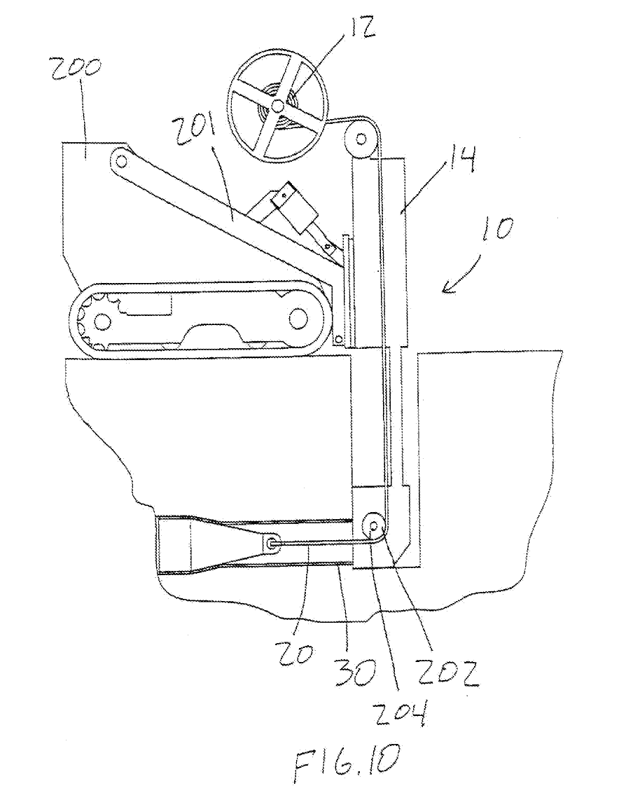

The cable handling system 10 can become rather heavy when designed to apply high pulling forces to the cable. In yet another embodiment of the cable handling system 10, shown in FIG. 10, the system may be mounted to lift arms of a work machine 200 known as a tool carrier. An example machine of this type is disclosed in the US Patent Application Publication 2005/0102866, incorporated herein by its reference. Such a machine 200 can be equipped with a backhoe suitable for excavating the pulling and access pits while the cable handling system 10 is attached to lift arms 201 at the opposite end. The frame 14 of the cable handling system 10 is preferably attached to the lift arms 201 by way of a well-known quick-attach adapter. The mounting includes a pivot axis suitable for orienting the line of pull at or near 90° to the longitudinal centerline of the tool carrier machine. This provides improved access on constricted job sites. The vertical orientation of the frame 14 also allows the pulling pit to be much shorter, and potentially narrower excavation. For improved transportability and greater ease of attaching and detaching from the lift arms 201 of the machine 200, the mounting may additionally include a rotational section. This allows the cable handling system 10 to be rotated to a horizontal position to reduce the overall center of gravity and clearance height.

With continued reference to FIG. 10, because the frame 14 of the cable handling system 10 is operated from a position above the pulling pit, the system includes a telescopic reaction assembly 202 to convert the vertical line of pull into alignment with the essentially horizontal centerline of the existing buried pipe that is being replaced. This is accomplished by way of a redirection pulley 204 mounted on a reaction fixture at the distant end of the telescopic assembly 202. Redirection creates reactionary forces that are resisted by contact of the reaction fixture against the exposed end of the existing pipe 30 and, perhaps, against the bottom of the pit. The reactionary forces may also be reacted against the ground surface above the pit by appendages (not shown) from the lower end of the frame 14, and by the resistive overturning moment of the machine's weight along its longitudinal ground contact. The system may have similar provisions as in the first embodiment of the cable handling system 10 for the mounting of a powered reel 12 and an idler pulley for redirecting the cable onto or off reel 12.

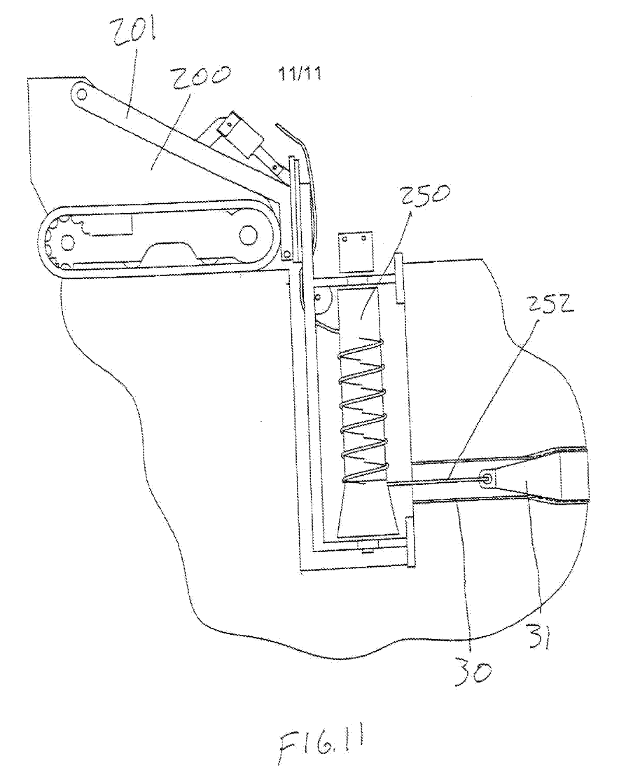

Turning now to FIG. 11, shown therein is yet another embodiment of the present invention. An alternative cable pulling mechanism comprises a capstan 250 mounted in a vertical position. The capstan 250 is lowered into a pit by the work machine 200. A number of wraps of a fiber cable 252 are made around the vertical capstan 250 sufficient to generate force to pull the bursting head 31 and the new pipe. The capstan is engaged, pulling on the free end of the cable 252 with sufficient force to pull the splitting head 31 through the old pipe 30. If more force is required, more wraps would be made around the capstand until a reasonable and comfortable force on the free end of the synthetic rope 252 is achieved. This device would do away with steel cable or chain by using high-strength synthetic fiber rope 252. In addition to being non-conductive, this rope weighs significantly less than equivalent strength steel chain or cables and is resistant to most chemicals. Further, this allows a compact pit size, reducing surface damage and the need for a large pit or frames with rollers and pullers to change the direction of pull.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. An assembly for bursting an underground pipe comprising:
a cable, connectable to a pipe bursting head;
at least one gripping element comprising a wedge, the at least one gripping element adapted to exert a force on the cable; and
a cable injection system comprising a wheel, the cable injection system adapted to feed the cable through the at least one gripping element.

2. The assembly of claim 1 comprising at least two gripping elements.

3. The assembly of claim 2 further comprising:
a first pair of cylinders, adapted to translate a first gripping element;
a second pair of cylinders, adapted to translate a second gripping element;
wherein the first pair of cylinders and the second pair of cylinders are not coplanar.

4. The assembly of claim 2 wherein:
each of the at least two gripping elements is movable between a first position and a second position; and
the at least two gripping elements are adapted to exert a force on the cable when moving from the first position to the second position.

5. The assembly of claim 4 wherein one of the at least two gripping elements is in a second position while another of the at least two gripping elements is in a first position.

6. The assembly of claim 4 wherein one of the at least two gripping elements is in a second position while another of the at least two gripping elements is in a second position.

7. The assembly of claim 1 further comprising a protrusion, wherein the protrusion is adapted to open the at least one gripping element.

8. The assembly of claim 7 wherein the protrusion opens the at least one gripping element when the at least one gripping element is in a forward position.

9. The assembly of claim 8 wherein the cable injection system feeds the cable through the at least one gripping element when the at least one gripping element is in the forward position.

10. The assembly of claim 1 further comprising a reel, wherein the reel is adapted to exert a tension on the cable.

11. The assembly of claim 1 comprising two modes:
a first mode wherein the cable injection system is adapted to inject the cable through the at least one gripping element and a pipe in a first direction; and
a second mode wherein the at least one gripping element is adapted to exert the force on the cable in a second direction;
wherein the first direction is opposite the second direction.

12. A method for bursting an underground pipe comprising the steps of;
feeding a cable through at least one gripping element;
feeding the cable through a length of an underground pipe;
attaching a pipe bursting head to an end of the cable; and
pulling the pipe bursting head through the length of the underground pipe with the at least one gripping element.

13. The method of claim 12 wherein the step of pulling the pipe bursting head comprises the steps of:
gripping the cable with a first gripping element in a first position;
pulling the cable with the first gripping element as the first gripping element moves to a second position;
gripping the cable with a second gripping element in another first position;
pulling the cable with the second gripping element as the first gripping element moves to another second position;
returning the first gripping element to the first position of the first gripping element; and
returning the second gripping element to the first position of the second gripping element.

14. The method of claim 12 wherein the step of pulling the pipe bursting head comprises the steps of:
gripping the cable with a first gripping element in a first position;
gripping the cable with a second gripping element in another first position;
pulling the cable with the first gripping element and the second gripping element; and
returning the first gripping element to the first position of the first gripping element and the second gripping element to the first position of the second gripping element.

15. The method of claim 12 further comprising the step of opening the at least one gripping element.

16. The method of claim 15 wherein the step of opening the at least one gripping element comprises moving the at least one gripping element to a forward position.

17. The method of claim 12 further comprising the step of tensioning the cable with a spool.
